(19) United States
(12) Patent Application Publication
(10) Pub. No.: US 2013/0240777 A1
(43) Pub. Date: Sep. 19, 2013

(54) HIGHLY THERMAL-CONDUCTIVE POLYIMIDE FILM CONTAINING GRAPHITE POWDER

(71) Applicant: E I DU PONT DE NEMOURS AND COMPANY, Wilmington, DE (US)

(72) Inventors: NAOFUMI YASUDA, Tokoname (JP); OSAMU YONENAGA, Tokyo (JP)

(73) Assignee: E I DU PONT DE NEMOURS AND COMPANY, Wilmington, DE (US)

(21) Appl. No.: 13/788,335

(22) Filed: Mar. 7, 2013

(30) Foreign Application Priority Data
Mar. 14, 2012 (JP) 2012-57699

(51) Int. Cl. C09K 5/14

(52) U.S. Cl. CPC C09K 5/14
USPC 252/75

(57) ABSTRACT

To obtain a thermal-conductive polyimide film having excellent mechanical characteristics, heat resistance, and the like, and additionally being excellent in thermal conductivity in the planar direction, having anisotropy in thermal conductivity between the planar direction and the thickness direction, and being excellent also in tear strength and moldability.

A highly thermal-conductive polyimide film, containing 5 weight % to less than 40 weight % scaly graphite powder relative to the entirety of the polyimide film, having a thermal conductivity in a planar direction of 1.0 W/m·K or higher and a thermal conductivity in a thickness direction of less than 1.0 W/m·K, and having a ratio of the thermal conductivity in the planar direction over the thermal conductivity in the thickness direction of 4.0 or higher.

### BACKGROUND

1. Technical Field

The present invention relates to a highly thermal-conductive polyimide film having excellent mechanical characteristics, heat resistance, and the like, and additionally having excellent thermal conductivity and electrical conductivity.

2. Related Art

Polyimide resins are widely used as films, tubes, molded bodies, and the like, making use of their excellent heat resistance, chemical resistance, electrical insulating property, and the like. Thermal-conductive polyimide resins containing highly thermal-conductive fillers mixed in polyimide resins are furthermore known, and are used in a variety of applications including in film shapes as base substrates of flexible printed circuit boards (FPC) (Patent Document 1) and in belt shapes as fixing belts for electrophotographic recording apparatuses (Patent Document 2).

However, in areas surrounding FPC or semiconductors, a problem of heat dissipation from the resins used as base substrates or insulating films has become more serious in conjunction with recent high-density mounting. Specifically, a problem occurred in the past in which heat accumulation occurred due to the use of resin films having inferior thermal conductivity and lacking anisotropy in thermal conductivity, and the reliability of the electronic devices was degraded. In particular, it was necessary to spread the heat from the heat-generating component in the planar direction and to prevent the heat from being transmitted to the underside.

Moreover, in areas surrounding electrophotographic apparatuses, a fixing method is adopted in which a toner is directly heat-fused on recording paper using a heater via a film-shaped endless belt. The problem of heat is aggravated in the aforementioned endless belts as well, and in the past, it was difficult to respond fully to the increasing of the fixing speed because resins being inferior in thermal conductivity and lacking anisotropy in thermal conductivity were used as the belt materials. In particular, when printing publications containing a mixture of postcards and copy paper, unevenness of temperature arose inside the belt, and it was furthermore necessary to spread the heat in the planar direction of the belt and to prevent the heat from being transmitted to the underside.

Therefore, polyimide films having improved thermal conductivity were developed (Patent Document 3). However, there was a desire for the development of polyimide films being further improved in electrical conductivity, and the like.

### BACKGROUND DOCUMENTS

### Patent Documents

Patent Document 1: Japanese Unexamined Patent Application Publication No. H10-226751
Patent Document 2: Japanese Unexamined Patent Application Publication No. 2007-192985
Patent Document 3: Japanese Unexamined Patent Application Publication No. 2010-275394

### SUMMARY OF THE INVENTION

### Problems to be Solved by the Invention

An object of the present invention is to provide a highly thermal-conductive polyimide film containing graphite powder, having excellent mechanical characteristics, heat resistance, and the like, and additionally being excellent in thermal conductivity in the planar direction, having anisotropy in thermal conductivity between the planar direction and the thickness direction, and being excellent in tear strength, moldability, and electrical conductivity.

### SUMMARY

Through research devoted at achieving the abovementioned object, the present inventors discovered that a highly thermal-conductive polyimide film can be provided by mixing scaly graphite powder in a polyimide resin; the inventors further pursued research based on this knowledge and arrived at the completion of the present invention.

That is, the present invention relates to the following aspects.

[1] A highly thermal-conductive polyimide film containing 5 weight % to less than 40 weight % scaly graphite powder relative to an entirety of the polyimide film, having a thermal conductivity in a planar direction of 1.0 W/m·K or higher and a thermal conductivity in a thickness direction of less than 1.0 W/m·K, and having a ratio of the thermal conductivity in the planar direction over the thermal conductivity in the thickness direction of 4.0 or higher,

[2] The polyimide film according to [1], wherein an aspect ratio of the scaly graphite powder is 50 or higher,

[3] The polyimide film according to [1] or [2], wherein a volume resistivity is 3.5×10⁵ Ωcm or higher,

[4] The polyimide film according to any of [1] to [3], wherein a surface resistance is 3.5×10⁵ Ωcm or higher,

[5] The polyimide film according to any of [1] to [4], wherein the scaly graphite powder is produced by sintering a polymeric resin film,

[6] The polyimide film according to [5], wherein the polymeric resin film is an aromatic polymeric film,

[7] The polyimide film according to [6], wherein the aromatic polymeric film is one or more kinds of polymeric films selected from a group including polyoxadiazole, polybenzothiazole, polybenzobisthiazole, polybenzoxazole, polybenzobisoxazole, poly(pyromellitimide), poly(p-phenylene isophthalamide), poly(m-phenylene benzoimidazole), poly(phenylene benzobisimidazole), polythiazole, and polyparaphenylene vinylene, having a thickness of 400 μm or smaller,

[8] The polyimide film according to any of [5] to [7], wherein the sintering is performed by heat treatment at a temperature of 2200° C. or higher in an inert gas atmosphere,

[9] A process for production of the polyimide film according to any of [1] to [8], wherein the polyimide film is obtained by mixing a scaly graphite powder in a polyamidic acid solution and performing thermal imidization,

[10] A process for production of the polyimide film according to any of [1] to [8], wherein the polyimide film is obtained by mixing a scaly graphite powder in a polyamidic acid solution and performing chemical imidization.

### Effect of the Invention

According to the present invention, a highly thermal-conductive polyimide film containing graphite powder, having excellent mechanical characteristics, heat resistance, and the like, and additionally being excellent in thermal conductivity in the planar direction, having anisotropy in thermal conductivity between the planar direction and the thickness direction, and being excellent in tear strength, moldability, and electrical conductivity can be provided.

### DETAILED DESCRIPTION

The highly thermal-conductive polyimide film of the present invention contains from 5 weight % to less than 40 weight % scaly graphite powder relative to the entirety of the polyimide film, has a thermal conductivity in a planar direction of 1.0 W/m·K or higher and a thermal conductivity in a thickness direction of less than 1.0 W/m·K, and has a ratio of the thermal conductivity in the planar direction over the thermal conductivity in the thickness direction of 4.0 or higher.

The term “polyimide resins” in the present invention indicates in general resins having imide bonds in the structures, and includes of course resins generally referred to as polyetherimides, polyesterimides, polyamidimides, and the like, as well as copolymers and blends with other resins.

In particular, reaction-curing-type straight-chain polyimide resins are preferred because they have excellent mechanical characteristics, heat resistance, and the like. Here, “reaction-curing-type straight-chain polyimide resins” indicates polyimide resins obtained by way of straight-chain polyamidic acids, being precursors, by dehydration and ring-opening of the amic acid sites, and representative examples include polyimide resins obtained by reacting pyromellitic acid dianhydride with 4,4′-diaminodiphenyl ether and subjecting the obtained straight-chain polyamidic acid to heating, catalyst addition, or the like. Reaction-curing-type straight-chain polyamidic acids are preferably used because they have carboxylic acid groups, amino groups, or other functional groups, and these functional groups strongly interact with inorganic fillers and can form strong bonds with graphite powder.

Known processes for imidization of polyimide resins include chemical imidization and thermal imidization, but either may be used in the present invention. When chemical imidization is performed using acid anhydrides and/or tertiary amines as imidization accelerators, a product having higher strength is obtained from the initial stage of molding compared to thermal imidization, and even if the resin contracts in the drying or dehydration reaction process during molding, there is no tearing of the resin, and this leads to an improvement of yield. For example, in the case in which molding is done in a film shape, molding is performed with the end portions being fixed in a pin frame, but in this case, strong tension is applied to the resin during molding and the film may tear. However, such does not easily occur if chemical imidization is used. The resin tears very easily particularly when it contains graphite powder (particularly when filled to 50 weight % or higher), but such problem can be avoided if chemical imidization is used. Also, in the case in which molding in a tube shape is performed, the resin is applied to a cylindrical mold and is then dried to be molded into a tube shape. Although the resin contracts during this drying, with thermal imidization, the film often tears because the strength during molding is weak. However, such tearing can be suppressed if chemical imidization is used. Moreover, when films containing inorganic fillers or thin molded bodies having thicknesses of 100 μm or larger and particularly 50μ or smaller, such as tubular objects, are fabricated, the films or molded bodies tear easily, but such problem can be avoided if chemical imidization is used.

Moreover, if chemical imidization is used, products that are strongly resistant to tearing even after molding are obtained, and tearing of the films or tubular objects due to contraction during cooling can be suppressed. Particularly in the case when molding the material as a tubular object, the tubular object must be extracted from the mold, but objects that are fabricated by thermal imidization or those that are highly packed with filler have weak tear strength, and the belt may be damaged in the extraction process. However, such damage can be greatly suppressed when fabrication is done by chemical imidization. In addition, even when tubular objects fabricated by chemical imidization are rotated for long periods of time as fixing belts or transferring and fixing belts, they can be used stably without tearing or breaking apart from the end portions.

The polyimide resin in the present invention may also be a polyimide resin obtained by adding a dehydrating agent and an acid anhydride and/or a tertiary amine as an imidization accelerator to a polyamidic acid, being a precursor, and then heating and firing.

A specific structure of a polyimide resin used in the present invention is described next.

Common polyimides are usually those that use tetracarboxylic dianhydride and diamine compounds as monomers. When producing the polyimide film of the present invention, a polyamidic acid solution (hereinafter referred to also as “polyamic acid solution”) is first obtained by polymerizing the diamine component and the acid dianhydride component in an organic solvent.

The compounds that can be used as acid dianhydrides in the present invention are not particularly limited but are preferably aromatic tetracarboxylic dianhydrides, and specific examples include pyromellitic dianhydride, 2,3,6,7-naphthalene tetracarboxylic dianhydride, 3,3′,4,4′-biphenyl tetracarboxylic dianhydride, 1,2,5,6-naphthalene tetracarboxylic dianhydride, 2,2′,3,3′-biphenyl tetracarboxylic dianhydride, 3,3′,4,4′-benzophenone tetracarboxylic dianhydride, 2,2-bis(3,4-dicarboxyphenyl)propane dianhydride, 3,4,9,10-perylene tetracarboxylic dianhydride, bis(3,4-dicarboxyphenyl)propane dianhydride, 1,1-bis(2,3-dicarboxyphenyl)ethane dianhydride, 1,1-bis(3,4-dicarboxyphenyl)ethane dianhydride, bis(2,3-dicarboxyphenyl)methane dianhydride, bis(3,4-dicarboxyphenyl)methane dianhydride, oxydiphthalic dianhydride, bis(3,4-dicarboxyphenyl)sulfone dianhydride, p-phenylenebis(trimellitic monoester anhydride), ethylenebis(trimellitic monoester anhydride), bisphenol A bis(trimellitic monoester anhydride), and similar compounds to each of these compounds. These compounds may be used singly, and may be used as mixtures combined in optional proportions.

The compounds that can be used as diamine components in the present invention are not particularly limited, but are preferably aromatic diamines, and specific examples include 4,4′-oxydianiline, p-phenylenediamine, 4,4′-diaminodiphenyl propane, 4,4′-diaminodiphenyl methane, benzidine, 3,3′-dicyclobenzidine, 4,4′-diaminodiphenyl sulfide, 3,3′-diaminodiphenyl sulfone, 4,4′-diaminodiphenyl sulfone, 4,4′-diaminodiphenyl ether, 3,3′-diaminodiphenyl ether, 3,4′-diaminodiphenyl ether, 1,5-diaminonaphthalene, 4,4′-diaminodiphenyl diethyl silane, 4,4′-diaminodiphenyl silane, 4,4′-diaminodiphenyl ethyl phosphine oxide, 4,4′-diaminodiphenyl N-methylamine, 4,4′-diaminodiphenyl N-phenylamine, 1,4-diaminobenzene(p-phenylenediamine), 1,3-diaminobenzene, 1,2-diaminobenzene, 2,2-bis(4-(4-aminophenoxy)phenyl)propane, and similar compounds to each of these compounds. These compounds may be used singly, and may be used as mixtures combined in optional proportions.

Specific examples of organic solvents that are used for forming the polyamic acid solution in the present invention include: dimethyl sulfoxide, diethyl sulfoxide, and other sulfoxide-based solvents; N,N-dimethylformamide, N,N-diethylformamide, and other formamide-based solvents; N,N-dimethyl acetamide, N,N-diethyl acetamide, and other acetamide-based solvents; N-methyl-2-pyrrolidone, N-vinyl-2-pyrrolidone, and other pyrrolidone-based solvents; phenol, o-, m-, or p-cresol, xylenol, halogenated phenol, catechol, and other phenol-based solvents; or hexamethyl phosphoramide, γ-butyrolactone, and other aprotic polar solvents. These are desirably used singly or as mixtures, but xylene, toluene, and other aromatic hydrocarbons can also be used.

The polymerization process may be carried out by any widely known process, and examples include the following. The polymerization processes are not limited to these, and other widely known processes may be used.

(1) A process in which the total amount of a diamine component is first put into a solvent, an acid dianhydride component is then added such that the amount added thereof is equivalent to the total amount of the diamine component, and polymerization is carried out.

(2) A process in which the total amount of an acid dianhydride component is first put into a solvent, an aromatic diamine component is then added such that the amount added thereof is equivalent to the amount of the acid dianhydride component, and polymerization is carried out.

(3) A process in which one diamine component is put into a solvent, an acid dianhydride component is then mixed in at a ratio to become 95 to 105 mol % relative to the reaction component for an amount of time required for the reaction, another diamine component is then added, the acid dianhydride component is next added such that the amounts of the diamine components and the acid dianhydride component become substantially equivalent, and polymerization is carried out.

(4) A process in which an acid dianhydride component is put into a solvent, one diamine component is then mixed in at a ratio to become 95 to 105 mol % relative to the reaction component for an amount of time required for the reaction, the acid dianhydride component is then added, another diamine component is next added such that the amounts of the diamine components and the acid dianhydride component become substantially equivalent, and polymerization is carried out.

(5) A process in which a polyamic acid solution (A) is prepared by reacting in a solvent one diamine component with an acid dianhydride component such that either one becomes in excess, and a polyamic acid solution (B) is then prepared by reacting another diamine component and the acid dianhydride component in another solvent such that either one becomes in excess. The polyamic acid solutions (A) and (B) thus obtained are then mixed, and polymerization is completed. At this time, in the case when the diamine component is in excess when preparing the polyamic acid solution (A), the acid dianhydride component is made to be in excess in the polyamic acid solution (B), and in the case when the acid dianhydride component is in excess in the polyamic acid solution (A), the diamine component is made to be in excess in the polyamic acid solution (B). By doing such, the diamine component and the acid dianhydride component used in these reactions become substantially equivalent quantities when the polyamic acid solutions (A) and (B) are mixed.

For stable feeding of the solution, the polyamic acid solution thus obtained contains a solid content of 5 to 40 weight %, preferably 10 to 30 weight %, and has a viscosity measured by a Brookfield viscometer of 100 to 20000 P (poise), preferably 1000 to 10000 poise. Also, the polyamic acid in the organic solvent solution may be partially imidized.

In the present invention, because graphite powder is mixed in the polyimide resin, a higher level of toughness is required for the polyimide compared with the case in which the polyimide is used alone. If the toughness of the polyimide itself is insufficient, it may be unsuitable for practical use because the toughness is inevitably degraded by mixing with the graphite powder. A polyimide containing pyromellitic dianhydride and 4,4′-diaminodiphenyl ether is most preferred from this viewpoint. The present structure is a structure that combines sufficient heat resistance and a high level of toughness and furthermore achieves a balance in which those characteristics can be maintained under a wide range of processing conditions.

In the present invention, a scaly graphite powder is preferable as a material for improving the thermal conductivity of the abovementioned polyimide resin. “Scaly graphite powder” indicates graphite powder having a scaly form, and “particulate graphite powder” indicates graphite powder in which the particles are in particulate form singly or in aggregates. Because the graphite powder is scaly, [the scales] easily contact each other, and are less likely to aggregate during molding processing of the polyimide compared with particulate fillers. Therefore, the thermal conductivity can be improved with the addition of smaller quantities of graphite powder compared with thermal-conductive inorganic fillers.

The graphite powder used in the present invention can be produced by sintering a polymeric resin film.

Examples of polymeric resin films include aromatic polymeric films and the like. Examples of aromatic polymeric films include one or more kinds of polymeric films selected from a group including polyoxadiazole, polybenzothiazole, polybenzobisthiazole, polybenzoxazole, polybenzobisoxazole, poly(pyromellitimide), poly(p-phenylene isophthalamide), poly(m-phenylene benzoimidazole), poly(phenylene benzobisimidazole), polythiazole, and polyparaphenylene vinylene, having a thickness of 400 μm or smaller, and the aromatic polymeric film is preferably a polyimide film.

The aforementioned sintering is performed through heat treatment in an inert gas atmosphere. The temperature of heat treatment is normally 2200° C. or higher, preferably 2400° C. or higher. By performing heat treatment in this temperature range, a scaly graphite powder having an aspect ratio of 50 or higher can be obtained.

The scaly graphite powder of the present invention can be produced by pulverizing film-shaped graphite after the aforementioned sintering. The pulverization can be performed using a jet mill, freezer mill, or other widely known means.

The aspect ratio of the scaly graphite powder of the present invention is usually 50 or higher. The upper limit is not particularly limited, but is on the order of 100.

The mean particle size of the graphite powder filler is not particularly limited, but is 5 μm or larger, preferably 10 μm or larger, and more preferably 20 μm or larger. In the present invention, the mean particle size may be within the aforementioned range. In a thin molded body having a thickness of 100 μm, a graphite powder having a mean particle size of 5 μm or larger is preferred because a scaly form is achieved, localized aggregation due to poor dispersion tends not to occur, and the thermal conductivity in the planar direction tends to be higher. The mean particle size in the present invention is the mean particle size (mean diameter lengthwise) obtained by randomly selecting particles from an SEM image observed at a magnification of 10,000 to 100,000 times using a scanning electron microscope (SEM), obtaining the diameter (particle size), and calculating the mean length of 30 particles. In the case when the number of projections is less than 30 in one SEM image, 30 or more particles are used in a plurality of images. The scanning electron microscope used for measurement of the mean particle size in the present invention is not particularly limited, but an example is the S5000 (trade name; manufactured by Hitachi).

The amount of the graphite powder that is mixed is usually from 5 weight % to less than 40 weight %, preferably 7 weight % to less than 35 weight %, and more preferably 10 to less than 33 weight %, relative to the entirety of the polyimide film. Two or more kinds of graphite powders having different particle sizes and numbers of layers can also be used. Less than 40 weight % is preferred because the mechanical characteristics and surface characteristics are maintained, a material that is not brittle is produced, and the material exhibits excellent moldability. Also, 5 weight % or more is preferred because thermal conductivity increases, and the material can be controlled to achieve the intended high thermal conductivity.

Moreover, because the graphite powder tends to aggregate when an imidization accelerator is added to accelerate the reaction, the amount of graphite powder that is added should be increased compared with the case of thermal imidization (for example, 1.1 times or more compared with thermal imidization). In addition, because the graphite powder is scaly and the thermal conductivity can be increased with a small amount added, there is no deterioration of mechanical strength due to the addition thereof. In addition, the water absorption rate can be kept to 5% or lower, and the amount of increase of the water absorption rate can be kept to a level that is on par with the original water absorption rate of the polyimide.

In addition to the aforementioned graphite powder, a thermal-conductive filler may also be added to the abovementioned polyimide resin. Preferred examples of thermal-conductive inorganic fillers that can be used to improve the heat conductivity of the polyimide resin include carbon black (for example, channel black, furnace black, ketjen black, acetylene black, and the like), silica, alumina, aluminum borate, silicon carbide, boron carbide, titanium carbide, tungsten carbide, silicon nitride, boron nitride, aluminum nitride, titanium nitride, mica, potassium titanate, barium titanate, calcium carbonate, titanium oxide, magnesium oxide, zirconium oxide, tin oxide, antimony-doped tin oxide, indium-tin oxide, and talc, and electrically conductive fillers (for example, alumina, tin oxide, potassium titanate, antimony-doped tin oxide, and the like). When these thermal-conductive fillers are used in addition to the graphite powder, the preferred usage amount of the fillers thereof is 1 to 100 parts by weight, and more preferably 5 to 50 parts by weight, per 100 parts by weight of the graphite powder.

Various processes can be adopted as processes for dispersing the added graphite powder and other thermal-conductive fillers in the polyimide resin.

If the polyimide resin is solvent soluble, a process may be adopted in which the filler preliminarily dispersed in a solvent is added to the polyimide resin dissolved in a solvent, and dispersion is promoted by mixing with an agitator blade and kneading with a triple roll or other kneading machine. Also, in reverse, a process is possible in which powders, pellets, or the like of the solvent-soluble polyimide are added to the filler preliminarily dispersed in a solvent and then thoroughly mixed. An effective process for preliminary dispersal is a process in which the filler is added to a solvent and is fully dispersed using an ultrasonic dispersing machine. The process that uses a triple roll subjects the filler to excessive shear force, and the shape may be destroyed as a result. Thus, the process using an agitator blade is preferred. The organic solvents used for forming the aforementioned polyamic acid solution may be used as the solvent.

When the polyimide resin is not solvent soluble, a process is possible in which the abovementioned preliminary dispersion liquid is added to a solution of the polyamic acid being the precursor of the polyimide, and then mixing, kneading, and the like, are performed by similar methods.

At this time, a dispersing agent for assisting dispersiveness of the filler can be added in a range such that significant deterioration of the characteristics of the polyimide is not caused. Because the state of dispersion is very homogeneous in the case in which metal salt is added as a dispersing material to the preliminary dispersion liquid, a fully homogeneous state of dispersion can be realized by stirring by hand as well. Moreover, when the polyamic acid solution is added little by little to the preliminary dispersion liquid while stirring, the dispersiveness is improved over that by the abovementioned reverse procedure.

Furthermore, another process by which particularly favorable characteristics can be obtained is a process in which the filler is added in advance to a solvent and is fully dispersed by ultrasonic dispersing machine, or the like, a diamine compound and an acid dianhydride, being the raw materials of the polyimide (polyamic acid), are added to this, and a polymerization reaction is carried out. By this process, dispersion on a micro level is favorably maintained by ultrasonic dispersion, or the like, and at the same time, dispersiveness on a macro level is also very favorable because agitation is performed throughout polymerization following the initial dispersion of the filler.

When the solution is a polyimide solution, this can be processed to an optional shape, and the solvent can then be volatilized by heating and in some instances by combining vacuum pressure, whereby a polyimide molded body can be obtained. When the solution is a polyamic acid solution, a polyimide molded body can be obtained by the same kinds of steps as in the case of a polyimide solution. In this case, acetic anhydride or other acid anhydride may be used as a dehydrating agent and/or a tertiary amine may be used as a catalyst for acceleration of imidization in advance of heating. However, because acid anhydrides not only accelerate the imidization reaction but also may cause breakage of the molecular main chain of the polyamic acid, the combination of an acid anhydride and a tertiary amine or the addition of a tertiary amine alone is preferred for mechanical characteristics of the polyimide, and a product having higher strength against tear propagation compared with imidization by heating alone is thereby obtained. Specifically, a product having a tear strength of 40 MPa or higher is obtained. Moreover, addition of a catalyst is much preferred because the heating time can be reduced and heat degradation of the film can be suppressed. With a production process that uses catalyst addition, in-plane orientation of the resin advances, and when scaly graphite powder is used, the graphite powder also tends to become oriented in a planar shape. As a result, the graphite powder oriented in the thickness direction is reduced in the case of a thin molded article having a thickness of 100 μm or smaller. Moreover, the molding time may be shortened, the production characteristics are dramatically improved, the strength is easily brought out during production, and the material does not become brittle during production.

The mixture obtained by the abovementioned process can be imidized by thermal imidization or chemical imidization, whereby a polyimide film can be obtained. The temperature of thermal imidization is not particularly limited, but it is usually 180 to 500° C., and in consideration of the properties and moldability of the obtained product, a temperature range of 200 to 450° C. is preferred. Moreover, it is more preferable to change the temperature in stages during heating; for example, there is a process in which thermal processing is performed at 180° C. to less than 250° C., thermal processing is next performed at 250° C. to less than 350° C., and thermal processing is next performed at 350° C. to less than 500° C. The time of imidization is not particularly limited. In the case of chemical imidization, a cyclization catalyst (imidization catalyst), dehydrating agent, gelation retardant, and the like, can be included in the mixture obtained by the abovementioned process.

Specific examples of cyclization agents used in chemical imidization include; trimethylamine, triethylenediamine, and other aliphatic tertiary amines; dimethyl aniline and other aromatic tertiary amines; and isoquinoline, pyridine, β-picoline, and other heterocyclic tertiary amines; but the use of at least one kind selected from heterocyclic tertiary amines is preferred. Specific examples of dehydrating agents used in chemical imidization include; acetic anhydride, propionic anhydride, butyric anhydride, and other aliphatic carboxylic acid anhydrides; and benzoic acid anhydride and other aromatic carboxylic acid anhydrides; but acetic anhydride and/or benzoic acid anhydride is preferred.

Examples of specific processes for molding into films and tubular objects are processes as follows.

The resin solution in which the abovementioned inorganic components are dispersed is applied onto an endless belt with the thickness controlled using a T-die, comma coater, doctor blade, or the like. The resin solution is heated and dried by hot blowing or the like, for example, at 30 to 200° C., until becoming self-supporting, and is then peeled from the endless belt. A film-shaped molded article can be obtained by sequentially passing the peeled semidry film through a high-temperature heating furnace (for example, passing through the heating furnace at 180° C. to less than 250° C., next passing through the heating furnace at 250° C. to less than 350° C., and next passing through the heating furnace at 350° C. to less than 500° C.) while controlling the length in the width direction by fixing both ends of the film in the width direction using pins or clips. Or, a process may be adopted in which the solution is applied by the same kind of process onto a continuous sheet-shaped supporting member of metal, or the like, and this is passed through the heating furnace, whereby a sheet-shaped fixed film or a sheet-shaped polyimide molded body is obtained, and the film or molded body is peeled from the supporting member sheet or the supporting member sheet is removed by etching or other means. The simplest method is to cut the film or sheet-shaped molded body thus obtained to a prescribed length and width and to then connect onto a belt or a tubular shape to obtain a belt or tube. An adhesive agent, adhesive tape, or the like, can be used for the connection, but this method may lead to inconveniences depending on the application because unevenness and cut lines are inevitably present at the connection points.

An example of a process for obtaining a tubular object is a process in which the resin solution is applied onto the inner surface or outer surface of a cylindrical mold, the solvent is volatilized by heating and drying or by drying under vacuum pressure, or the like, and the resulting product is heated to a final sintering temperature, or the resulting product is first peeled, fitted onto the outer perimeter of another mold for finally stipulating the inner diameter, and heated to a final sintering temperature. During application of the resin solution onto the cylindrical mold, it is effective to rotate the mold in order to mitigate variations in thickness due to collapsing of the resin solution. The final sintering temperature must be suitably selected according to the structure of the polyimide and the heat resistance of the added carbon, but favorable ranges are 350° C. to 500° C. in the case when heating and firing from the polyamic acid state in non-thermoplastic polyimide, and −20° C. to +100° C. relative to the glass transition temperature of the polyimide in the case of thermoplastic polyimide. The glass transition temperature of the aforementioned polyimide may vary depending on the components, but 300 to 450° C. is preferred.

The thermal conductivity in the planar direction of the highly thermal-conductive polyimide film of the present invention is 1.0 W/m·K or higher, more preferably 2.0 W/m·K or higher, and particularly preferably 5.0 W/m·K or higher. The thermal conductivity in the planar direction is preferably 1.0 W/m·K or higher because the stored heat in a heat-generating component mounted on a substrate or the heat of temperature irregularity on a fixing belt can effectively be spread, and a temperature increase on the underside of the substrate can be prevented or acceleration of fixing becomes possible. The thermal conductivity in the planar direction is preferably 100 W/m·K or lower.

The thermal conductivity in the thickness direction is preferably less than 1.0 W/m·K, more preferably 0.8 W/m·K or less, and more preferably 0.6 W/m·K or less. Also, the thermal conductivity in the thickness direction is preferably 0.15 W/m·K or higher, and more preferably greater than 0.25 W/m·K. The thermal conductivity in the thickness direction is preferably in the abovementioned range because the stored heat in a heat-generating component mounted on a substrate or the heat of temperature irregularity on a fixing belt can be effectively spread, and a temperature increase on the underside of the substrate can be prevented or acceleration of fixing becomes possible.

Moreover, the ratio of the thermal conductivity in the planar direction over the thermal conductivity in the thickness direction is usually 4 or higher, preferably 4.3 or higher, and more preferably 5 or higher. The ratio of the thermal conductivity in the planar direction over the thermal conductivity in the thickness direction is preferably 5 or higher because the stored heat in a heat-generating component mounted on a substrate or the heat of temperature irregularity on a fixing belt can be effectively spread, and a temperature increase on the underside of the substrate can be prevented or acceleration of fixing becomes possible. The ratio of the thermal conductivity in the planar direction over the thermal conductivity in the thickness direction is preferably 1000 or less.

The volume resistivity of the highly thermal-conductive polyimide film of the present invention, considering electrical conductivity, is usually 3.5×10⁵ Ωcm or higher, and preferably 4.0×10⁵ Ωcm or higher.

The surface resistance of the highly thermal-conductive polyimide film of the present invention, considering electrical conductivity, is usually 3.5×10⁵ Ωcm or higher, and preferably 4.0×10⁵ Ωcm or higher.

The thickness of the highly thermal-conductive polyimide film of the present invention is usually from 5 μm to 100 μm or less, and preferably from 10 μm to 90 μm less. A thickness of 5 μm or larger is preferred because the film has sufficient strength. Also, 100 μm or smaller is preferred because the ability of the added graphite powder to orient in the planar direction is improved, the heat conductivity in the planar direction is increased, and the ratio of the thermal conductivity in the planar direction over the thermal conductivity in the thickness direction is increased.

The tear strength of the highly thermal-conductive polyimide film of the present invention is preferably 40 MPa or higher, more preferably 50 MPa or higher, and even more preferably 60 MPa or higher. The tear strength of the highly thermal-conductive polyimide film of the present invention is preferably 500 MPa or lower. The elongation is not particularly limited, but is preferably to the extent from 10% to 50% or less. The coefficient of thermal expansion (CTE) of the highly thermal-conductive polyimide film is a value that is measured using a Shimadzu TMA-50 with conditions of a temperature measurement range of 50 to 200° C. and a rate of temperature increase of 10° C./minute, and is usually 9 to 40 ppm/° C., and preferably 10 to 30 ppm/° C. There is a tendency to become inferior in heat resistance when the CTE is greater than 40 ppm/° C.

### EXAMPLES

The present invention is next described in further detail giving embodiments, but the present invention is not limited in any way whatsoever to these embodiments, and many modifications are possible by those skilled in the art within the technical concept of the present invention.

### (Thermal Conductivity in the Planar Direction and the Thickness Direction)

The thermal conductivity in the planar direction and the thickness direction can be calculated by λ=α×d×Cp. Here, λ is the thermal conductivity, α is the thermal diffusivity, d is the density, and Cp is the specific heat capacity. The thermal diffusivity in the planar direction, thermal diffusivity in the thickness direction, density, and specific heat capacity of the film can be obtained by the methods described below.

### (Measurement of Thermal Diffusivity in the Planar Direction)

The thermal diffusivity in the planar direction was measured using a thermal diffusivity measurement apparatus (“LaserPit” obtainable from ULVAC-RIKO) based on a light alternating method under conditions that included a 25° C. atmosphere and 10 Hz alternating current with the film being cut into a 3 mm×30 mm sample shape.

### (Thermal Diffusivity in the Thickness Direction)

The thermal diffusivity and the thermal conductivity were measured using a Bruker Nanoflash LFA447 in a 25° C. atmosphere, using a film that was cut to a diameter of 20 mm and had both surfaces darkened by applying a carbon spray.

### (Measurement of Density)

The density of the film was calculated by dividing the mass (g) of the film by the volume (cm³) of the film, which was calculated by multiplying the length, width, and thickness dimensions of the film.

### (Measurement of Thickness)

The thickness of the film was measured by measuring the thickness of any 10 points on a 50 mm×50 mm film using a thickness gauge (VL-50A, manufactured by Mitsutoyo) at a constant room temperature of 25° C. and then taking the mean value of the measurements as the measured thickness of the film.

### (Measurement of Specific Heat)

The specific heat of the film was measured using a DSC-7 differential scanning calorimeter manufactured by Perkin Elmer under conditions that included a rate of temperature increase of 10° C./min, a standard sample of sapphire, an atmosphere of dry nitrogen gas flow, and a measurement temperature of 25° C.

### (Moldability)

Whether in film molding using a pin frame or in molding of a tubular object having an inner diameter of 70 mm, cases when tearing did not occur during molding are indicated with “O” and cases when tearing occurred are indicated with “X.”

### (Tear Strength)

Testing was performed using a tensile tester in accordance with JIS K 7128 “Testing Methods for Tear Resistance of Plastic Film and Sheeting (Method C: Right-angle tear method).” The test speed was 100 mm/minute.

### (Volume Resistivity and Surface Resistance)

Testing was performed using an ULTRA HIGH RESISTANCE METER R8340 (manufactured by ADC) under the following conditions.

Sample dimension: 100×100 mm

Electrode shape: main power supply φ 50 mm, annular electrode inner diameter φ 70 mm, outer diameter φ 80 mm, counter electrode 103 mm

Electrode material: Conductive paste

Applied voltage: 500 V/minute, applied load: 5 kg

Preprocessing: C—90 h/22±1° C./60±5% RH, test temperature 23° C./57% RH

### (CTE)

Measurement was performed using a Shimadzu TMA-50 under conditions that included a measurement temperature range of 50 to 200° C. and a rate of temperature increase of 10° C./minute.

### (Young's Modulus and Breaking Point Elongation)

The breaking elongation was measured taking the elongation when the sample broke on a tension-strain curve obtained with a tension rate of 300 mm/min, using a tensilon-type tensile tester manufactured by ORIENREC at room temperature in accordance with JIS K 7113:1995. Young's modulus was obtained from the slope of the initial rising portion.

### Example 1

Seventy grams (70 g) of a solution of polyamic acid in DMAc (solid content concentration of 23.7%, solution viscosity of 3,500 poise) obtained using 4,4′-diaminodiphenyl ether as an aromatic diamine and pyromellitic dianhydride as an aromatic tetracarboxylic dianhydride was prepared. Meanwhile, 1.83 g of graphite powder (scaly, mean particle size 10 to 12 μm, aspect ratio 100) was added to DMAc and an 11% slurry was prepared.

The entire quantity of the slurry was then added to and kneaded with the aforementioned polyamic acid. The obtained mixture was cast into a film shape on a glass plate using an applicator and then dried for 20 minutes at 90° C., and a self-supporting polyamic acid film was obtained. Furthermore, the film was peeled from the glass plate and moved to a pin frame, and was heat treated for 30 minutes at 200° C., 20 minutes at 300° C., and 5 minutes at 400° C., and a 50 μm polyimide film was obtained. The concentration of graphite powder in the present film is 10 weight %. The results of the measurements of the various characteristics are shown in Table 1 below.

### Example 2

Seventy grams (70 g) of a solution of polyamic acid in DMAc (solid content concentration of 23.7%, solution viscosity of 3,500 poise) obtained using 4,4′-diaminodiphenyl ether as an aromatic diamine and pyromellitic dianhydride as an aromatic tetracarboxylic dianhydride was prepared. Meanwhile, 4.13 g of graphite powder (scaly, mean particle size 10 to 12 μm, aspect ratio 100) was added to DMAc and an 11% slurry was prepared. The entire quantity of the slurry was then added to and kneaded with the aforementioned polyamic acid. The obtained mixture was cast into a film shape on a glass plate using an applicator and then dried for 20 minutes at 90° C., and a self-supporting polyamic acid film was obtained. Furthermore, the film was peeled from the glass plate and moved to a pin frame, and was heat treated for 30 minutes at 200° C., 20 minutes at 300° C., and 5 minutes at 400° C., and a 50 μm polyimide film was obtained. The concentration of graphite powder in the present film is 20 weight %. The results of the measurements of the various characteristics are shown in Table 1 below.

### Example 3

Seventy grams (70 g) of a solution of polyamic acid in DMAc (solid content concentration of 23.7%, solution viscosity of 3,500 poise) obtained using 4,4′-diaminodiphenyl ether as an aromatic diamine and pyromellitic dianhydride as an aromatic tetracarboxylic dianhydride was prepared. Meanwhile, 7.07 g of graphite powder (scaly, mean particle size 10 to 12 μm, aspect ratio 100) was added to DMAc and an 11% slurry was prepared.

The entire quantity of the slurry was then added to and kneaded with the aforementioned polyamic acid. The obtained mixture was cast into a film shape on a glass plate using an applicator and then dried for 20 minutes at 90° C., and a self-supporting polyamic acid film was obtained. Furthermore, the film was peeled from the glass plate and moved to a pin frame, and was heat-treated for 30 minutes at 200° C., 20 minutes at 300° C., and 5 minutes at 400° C., and a 50 μm polyimide film was obtained. The concentration of graphite powder in the present film is 30 weight %. The results of the measurements of the various characteristics are shown in Table 1 below.

### Example 4

Seventy grams (70 g) of a solution of polyamic acid in DMAc (solid content concentration of 23.7%, solution viscosity of 3,500 poise) obtained using 4,4′-diaminodiphenyl ether as an aromatic diamine and pyromellitic dianhydride as an aromatic tetracarboxylic dianhydride was prepared. Meanwhile, 1.83 g of graphite powder (scaly, mean particle size 10 to 12 μm, aspect ratio 100) was added to DMAc and an 11% slurry was prepared.

The entire quantity of the slurry was then added to and kneaded with the aforementioned polyamic acid. The obtained mixture was cooled to −5° C., 9.6 g of β-picoline and 10.5 g of acetic anhydride were added to the aforementioned mixture, the mixture was cast into a glass plate shape using an applicator, and a self-supporting gel film was obtained.

The film was grasped with a metal frame and heat treated for 30 minutes at 200° C., 20 minutes at 300° C., and 5 minutes at 400° C., and a polyimide film having a thickness of 50 μm was obtained. The concentration of graphite powder in the present film is 10 weight %. The results of the measurements of the various characteristics are shown in Table 1 below.

### Example 5

Seventy grams (70 g) of a solution of polyamic acid in DMAc (solid content concentration of 23.7%, solution viscosity of 3,500 poise) obtained using 4,4′-diaminodiphenyl ether as an aromatic diamine and pyromellitic dianhydride as an aromatic tetracarboxylic dianhydride was prepared. Meanwhile, 4.13 g of graphite powder (scaly, mean particle size 10 to 12 μm, aspect ratio 100) was added to DMAc and an 11% slurry was prepared.

The entire quantity of the slurry was then added to and kneaded with the aforementioned polyamic acid. The obtained mixture was cooled to −5° C., 9.6 g of β-picoline and 10.5 g of acetic anhydride were added to the aforementioned mixture, the mixture was cast into a glass plate shape using an applicator, and a self-supporting gel film was obtained.

The film was grasped with a metal frame and heat treated for 30 minutes at 200° C., 20 minutes at 300° C., and 5 minutes at 400° C., and a polyimide film having a thickness of 50 μm was obtained. The concentration of graphite powder in the present film is 20 weight %. The results of the measurements of the various characteristics are shown in Table 1 below.

### Example 6

Seventy grams (70 g) of a solution of polyamic acid in DMAc (solid content concentration of 23.7%, solution viscosity of 3,500 poise) obtained using 4,4′-diaminodiphenyl ether as an aromatic diamine and pyromellitic dianhydride as an aromatic tetracarboxylic dianhydride was prepared. Meanwhile, 7.07 g of graphite powder (scaly, mean particle size 10 to 12 μm, aspect ratio 100) was added to DMAc and an 11% slurry was prepared.

The entire quantity of the slurry was then added to and kneaded with the aforementioned polyamic acid. The obtained mixture was cooled to −5° C., 9.6 g of β-picoline and 10.5 g of acetic anhydride were added to the aforementioned mixture, the mixture was cast into a glass plate shape using an applicator, and a self-supporting gel film was obtained. The film was grasped with a metal frame and heat treated for 30 minutes at 200° C., 20 minutes at 300° C., and 5 minutes at 400° C., and a polyimide film having a thickness of 50 μm was obtained. The concentration of graphite powder in the present film is 30 weight %. The results of the measurements of the various characteristics are shown in Table 1 below.

### Comparative Example 1

Seventy grams (70 g) of a solution of polyamic acid in DMAc (solid content concentration of 23.7%, solution viscosity of 3,500 poise) obtained using 4,4′-diaminodiphenyl ether as an aromatic diamine and pyromellitic dianhydride as an aromatic tetracarboxylic dianhydride was prepared. Forty-eight grams (48 g) of DMAc was then added to and mixed with the aforementioned polyamic acid. The obtained mixture was cast into a film shape on a glass plate using an applicator and then dried for 20 minutes at 90° C., and a self-supporting polyamic acid film was obtained. Furthermore, the film was peeled from the glass plate and moved to a pin frame, and was heat-treated for 30 minutes at 200° C., 20 minutes at 300° C., and 5 minutes at 400° C., and a 50 μm polyimide film was obtained. The results of the measurements of the various characteristics are shown in Table 1 below.

### Comparative Example 2

Seventy grams (70 g) of a solution of polyamic acid in DMAc (solid content concentration of 23.7%, solution viscosity of 3,500 poise) obtained using 4,4′-diaminodiphenyl ether as an aromatic diamine and pyromellitic dianhydride as an aromatic tetracarboxylic dianhydride was prepared. Twenty-eight grams (28 g) of DMAc was then added to the aforementioned polyamic acid. The obtained mixture was cooled to −5° C., 9.6 g of β-picoline and 10.5 g of acetic anhydride were added to the aforementioned mixture, the mixture was cast into a glass plate shape using an applicator, and a self-supporting gel film was obtained. The film was grasped with a metal frame and heat treated for 30 minutes at 200° C., 20 minutes at 300° C., and 5 minutes at 400° C., and a polyimide film having a thickness of 50 μm was obtained. The results of the measurements of the various characteristics are shown in Table 1 below.

TABLE 1

| | | | | | | | | Comparative | Comparative |
|---|---|---|---|---|---|---|---|---|---|
| | | Example 1 | Example 2 | Example 3 | Example 4 | Example 5 | Example 6 | Example 1 | Example 2 |
| Imidization | | Thermal | Thermal | Thermal | Chemical | Chemical | Chemical | Thermal | Chemical |
| Method | | Imidzation | Imidization | Imidization | Imidization | Imidization | Imidization | Imidization | Imidization |
| Amount of | wt % | 10 | 20 | 30 | 10 | 20 | 30 | 0 | 0 |
| Graphite | | | | | | | | | |
| Powder | | | | | | | | | |
| Added | | | | | | | | | |
| C.T.E. | ppm/C | 38.3 | 30.5 | 24.5 | 24.2 | 18.6 | 13 | 40.5 | 28.0 |
| Young's | Gpa | 3.1 | 3.5 | 4.0 | 3.2 | 4.3 | 4.6 | 3.0 | 3 |
| Modulus | | | | | | | | | |
| Strength | MPa | 94 | 82 | 74 | 146 | 121 | 109 | 149 | 156 |
| Elongation | % | 15.0 | 12.0 | 10.0 | 43.0 | 29.2 | 22.1 | 61.0 | 62.4 |
| Thermal | Z | 0.44 | 0.67 | 1.00 | 0.22 | 0.24 | 0.27 | 0.17 | 0.17 |
| Conductivity | XY | 1.900 | 2.92 | 4.37 | 1.43 | 2.02 | 3.64 | 0.69 | 0.72 |
| (W/m · K) | | | | | | | | | |
| XY/Z | — | 4.3 | 4.4 | 4.4 | 6.5 | 8.4 | 13.5 | 4.1 | 4.2 |
| Volume | Ω cm | 1.8 × 10¹² | 1.5 × 10⁸ | 4.0 × 10⁵ | 3.6 × 10¹⁵ | 1.5 × 10¹⁴ | 1.9 × 10⁷ | 1.0 × 10¹⁶ | 3.0 × 10¹⁶ |
| Resistivity | | | | | | | | | |
| Surface | Ω | 9.0 × 10¹³ | 1.8 × 10¹⁰ | 4.0 × 10⁶ | 9.4 × 10¹⁶ | 9.4 × 10¹⁶ | 9.6 × 10¹⁴ | 9.4 × 10¹⁶ | 9.4 × 10¹⁶ |
| Resistance | | | | | | | | | |
| Moldability | | ∘ | ∘ | ∘ | ∘ | ∘ | ∘ | ∘ | ∘ |

From the above results, it was confirmed that the highly thermal-conductive polyimide film of the present invention has excellent mechanical characteristics, heat resistance, and the like, and additionally is excellent in thermal conductivity in the planar direction, has anisotropy in thermal conductivity between the planar direction and the thickness direction, and exhibits excellent tear strength, film formability, and electrical conductivity.

### INDUSTRIAL APPLICABILITY

The highly thermal-conductive polyimide film of the present invention has excellent mechanical characteristics, heat resistance, and the like, and additionally is excellent in thermal conductivity in the planar direction, has anisotropy in thermal conductivity between the planar direction and the thickness direction, exhibits excellent tear strength, film formability, and electrical conductivity, and is useful as a material for electrical components.

1. A highly thermal-conductive polyimide film, comprising from 5 weight % to less than 40 weight % scaly graphite powder relative to an entirety of the polyimide film, having a thermal conductivity in a planar direction of 1.0 W/m·K or higher and a thermal conductivity in a thickness direction of less than 1.0 W/m·K, and having a ratio of the thermal conductivity in the planar direction over the thermal conductivity in the thickness direction of 4.0 or higher.

2. The polyimide film according to claim 1, wherein an aspect ratio of the scaly graphite powder is 50 or higher.

3. The polyimide film according to claim 1, wherein a volume resistivity is 3.5×10⁵ Ωcm or higher.

4. The polyimide film according to claim 1, wherein a surface resistance is 3.5×10⁵ Ωcm or higher.

5. The polyimide film according to claim 1, wherein the scaly graphite powder is produced by sintering a polymeric resin film.

6. The polyimide film according to claim 5, wherein the polymeric resin film is an aromatic polymeric film.

7. The polyimide film according to claim 6, wherein the aromatic polymeric film is one or more kinds of polymeric films selected from a group including polyoxadiazole, polybenzothiazole, polybenzobisthiazole, polybenzoxazole, polybenzobisoxazole, poly(pyromellitimide), poly(p-phenylene isophthalamide), poly(m-phenylene benzoimidazole), poly(phenylene benzobisimidazole), polythiazole, and polyparaphenylene vinylene, having a thickness of 400 μm or smaller.

8. The polyimide film according to claim 5, wherein the sintering is performed by heat treatment at a temperature of 2200° C. or higher in an inert gas atmosphere.

9. (canceled)

10. (canceled)
